(19) United States
(12) Patent Application Publication
(10) Pub. No.: US 2023/0019315 A1
(43) Pub. Date: Jan. 19, 2023

(54) TERMINAL BLOCK

(71) Applicant: SUMITOMO WIRING SYSTEMS, LTD., Mie (JP)

(72) Inventor: Yuji ITO, Mie (JP)

(21) Appl. No.: 17/783,271

(22) PCT Filed: Nov. 24, 2020
(86) PCT No.: PCT/JP2020/043654

§ 371 Date: Jun. 8, 2022

(30) Foreign Application Priority Data
Dec. 12, 2019 (JP) 2019-224361

(51) Int. Cl. H01R 9/24; H01R 31/06; H01R 13/74

(52) U.S. Cl. CPC H01R 9/24; H01R 9/2491; H01R 31/06; H01R 13/748; H02K 5/225

(57) ABSTRACT

One aspect of the present disclosure provides a terminal block capable of improving mounting position accuracy. A terminal block according to the one aspect of the present disclosure includes a plate made of metal and to be fixed to a first case made of metal, a housing held on the plate, and a plurality of terminals held in the housing. The plate includes a first positioning hole through which a first positioning pin is inserted.

### TECHNICAL FIELD

The present disclosure relates to a terminal block.

### BACKGROUND

Patent Document 1 describes a terminal block to be connected to a motor case. This terminal block is used to connect a motor and an inverter. The terminal block disclosed in Patent Document 1 includes a metal plate to be mounted and fixed to the motor case, a connector housing integrally molded to the metal plate and a conductive plate held in the connector housing. The terminal block is positioned with respect to the motor case by inserting a positioning pin integrally provided to the connector housing into a pin hole of the motor case. The conductive plate is fastened to a device-side busbar provided inside the motor case and a terminal connected to an end of a wire disposed from the inverter toward the motor case is fastened to the conductive plate.

Further, Patent Document 2 discloses a terminal block interposed between a motor case and an inverter case placed on the motor case. This terminal block includes a lower base into which a motor-side connection terminal on the side of the motor case is accommodated, and an upper base to which an inverter-side connection terminal on the side of the inverter case is fixed.

### PRIOR ART DOCUMENT

### Patent Document

Patent Document 1: JP 2012-195066 A

Patent Document 2: JP 2015-062344 A

### SUMMARY OF THE INVENTION

### Problems to be Solved

It is considered to directly connect the conductive plate of the terminal block to the inverter by placing the inverter case on the motor case. Accordingly, the inventor of the present application studied a terminal block 100 as a reference example shown in FIG. 6.

The terminal block 100 shown in FIG. 6 includes a plate 101 made of metal and to be mounted and fixed to a motor case 110, a housing 102 made of resin and integrally molded to the plate 101 and a terminal 103 made of metal and held in the housing 102. The housing 102 includes a plurality of positioning pins 104. The motor case 110 includes an insertion opening 111 into which a part of the housing 102 of the terminal block 100 and a part of the terminal 103 are inserted, pin holes 113 into which the positioning pins 104 of the housing 102 are inserted, and a plurality of positioning pins 114. An inverter case 120 includes an insertion opening 121 into which another part of the housing 102 of the terminal block 100 and another part of the terminal 103 are inserted, and pin holes 122 into which the positioning pins 114 of the motor case 110 are inserted.

The terminal block 100 and the motor case 110 are positioned with respect to each other by the plurality of positioning pins 104 formed on the housing 102 of the terminal block 100 and the pin holes 113 provided in the motor case 110. The motor case 110 and the inverter case 120 are positioned with respect to each other by the positioning pins 114 formed on the motor case 110 and the pin holes 122 formed in the inverter case 120. The housing 102 of the terminal block 100 is provided with a sealing member 105 for sealing between the housing 102 and the inverter case 120.

In the terminal block 100 shown in FIG. 6, since the positioning pins 104 are made of resin, positional variations easily occur due to shrinkage during molding, the tilt of the positioning pins 104 and the like. Thus, the pin holes 113 of the motor case 110 are formed with large tolerances for the designed positions of the positioning pins 104 of the terminal block 100. Further, intervals between the positioning pins 104 of the terminal block 100 and the positioning pins 114 of the motor case 110 vary. Thus, the positioning pins 114 of the motor case 110 are formed with large tolerances. The insertion opening 121 of the inverter case 120 is formed to be largely separated from the housing 102 to absorb mounting variations of the terminal block 100. Then, the large sealing member 105 is necessary to seal between the terminal block 100 and the inverter case 120 in a watertight manner. This leads to the enlargement of the terminal block 100. If the mounting variations of the terminal block 100 are large, the sealing member 105 may be separated from the inverter case 120 and watertight sealing may not be sufficiently provided between the terminal block 100 and the inverter case 120.

It is aimed to provide a terminal block capable of improving mounting position accuracy.

### Means to Solve the Problem

The present disclosure is directed to a terminal block to be interposed between a first case and a second case, wherein the first case is made of metal and includes a first positioning pin projecting toward the second case, the second case is made of metal and includes a first pin hole, the first positioning pin being inserted into the first pin hole, the terminal block includes a plate made of metal and to be fixed to the first case, a housing held on the plate and a plurality of terminals held in the housing, and the plate includes a first positioning hole, the first positioning pin being inserted through the first positioning hole.

### Effect of the Invention

According to the present disclosure, it is possible to provide a terminal block capable of improving mounting position accuracy.

### BRIEF DESCRIPTION OF THE DRAWINGS

FIG. 1 is a plan view of a terminal block according to an embodiment.

FIG. 2 is a side view of the terminal block.

FIG. 3 is a section along 3-3 of FIG. 1.

FIG. 4 is a diagram showing a first positioning hole and a second positioning hole.

FIG. 5 is a diagram showing the terminal block, a first case and a second case.

FIG. 6 is a section of a terminal block as a reference example considered by an inventor.

### DETAILED DESCRIPTION TO EXECUTE THE INVENTION

### Description of Embodiments of Present Disclosure

First, embodiments of the present disclosure are listed and described.

[1] The terminal block of the present disclosure is a terminal block to be interposed between a first case and a second case, wherein the first case is made of metal and includes a first positioning pin projecting toward the second case, the second case is made of metal and includes a first pin hole, the first positioning pin being inserted into the first pin hole, the terminal block includes a plate made of metal and to be fixed to the first case, a housing held on the plate and a plurality of terminals held in the housing, and the plate includes a first positioning hole, the first positioning pin being inserted through the first positioning hole.

According to this configuration, the terminal block is positioned with respect to the first case by the first positioning pin inserted through the first positioning hole of the plate. Since being made of metal, the plate and the first case have small shape errors and are formed with small tolerances as compared to a positioning pin made of resin. Thus, it is not necessary to set large tolerances between the first case and the terminal block and between the terminal block and the second case. As a result, the mounting position accuracy of the terminal block can be improved.

[2] Preferably, the first case includes a second positioning pin projecting toward the second case, the second case includes a second pin hole, the second positioning pin being inserted into the second pin hole, and the plate includes a second positioning hole, the second positioning pin being inserted through the second positioning hole.

According to this configuration, the terminal block can be positioned, for example, with respect to a rotation direction about the first positioning pin by the first positioning pin inserted through the first positioning hole and the second positioning pin inserted through the second positioning hole.

[3] Preferably, the plurality of terminals are arrayed along a first direction, and the first positioning hole and the second positioning hole are arrayed along a second direction intersecting the first direction and arranged across the plurality of terminals when viewed from the first direction.

According to this configuration, a distance between the first and second positioning holes can be increased by arranging the first and second positioning holes across the terminals. In this way, the terminal block can be positioned with higher accuracy in the rotation direction of the terminal block.

[4] Preferably, the first positioning hole has a circular shape, the second positioning hole extends along the second direction, a length of the second positioning hole in a third direction orthogonal to the second direction is equal to a diameter of the first positioning hole, and a length of the second positioning hole in the second direction is longer than the diameter of the first positioning hole.

According to this configuration, since the second positioning hole is long in the second direction, the first positioning pin can be easily inserted through the first positioning hole and the second positioning pin can be easily inserted through the second positioning hole even if a distance between the first and second positioning pins varies. Further, the inclination of the terminal block can be suppressed by making the length of the second positioning hole in the third direction equal to the diameter of the first positioning hole. Therefore, the suppression of the inclination of the terminal block and workability in assembling the terminal block with the first case can be combined.

### Details of Embodiment of Present Disclosure

A specific example of a terminal block of the present disclosure is described below with reference to the drawings. “Parallel” and “orthogonal” in this specification mean not only strictly parallel and orthogonal, but also substantially parallel and orthogonal within a range in which functions and effects in the embodiment are achieved. Note that the present invention is not limited to these illustrations and is intended to be represented by claims and include all changes in the scope of claims and in the meaning and scope of equivalents.

(Relationship of Terminal Block, First Case and Second Case)

As shown in FIG. 5, a terminal block 10 is interposed between a first case 60 and a second case 70. The first and second cases 60, 70 are, for example, cases of electrical devices. The electrical devices are, for example, a motor and an inverter to be installed in a vehicle. The terminal block 10 is a connection device for electrically connecting a plurality of electrical devices to each other. In this embodiment, the first case 60 is, for example, a motor case of the motor to be installed in the vehicle. Further, in this embodiment, the second case 70 is, for example, an inverter case of the inverter to be installed in the vehicle.

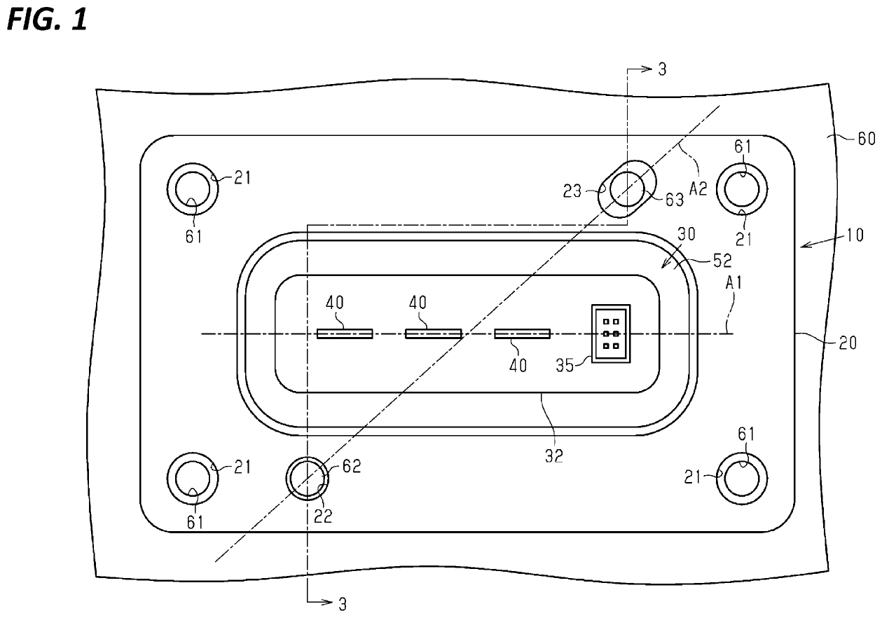

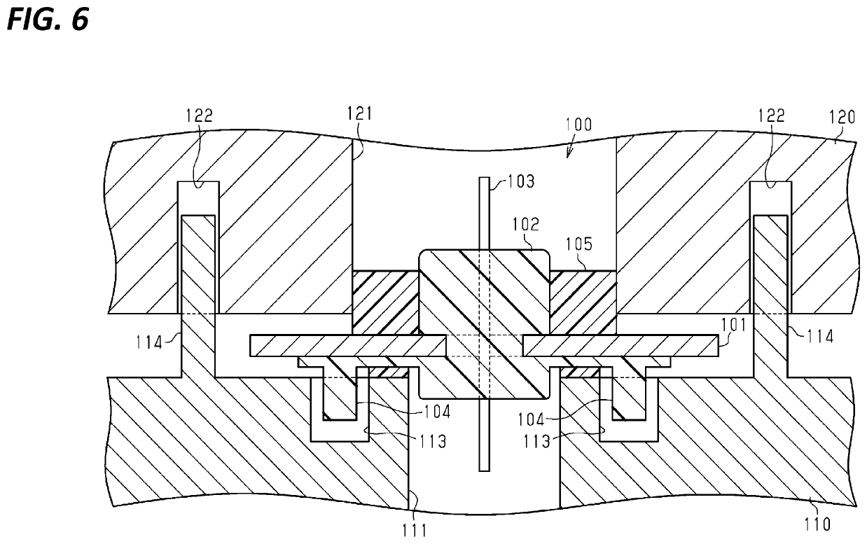

As shown in FIG. 1, the first case 60 includes a plurality of bolt insertion holes 61. The terminal block 10 is fixed to the first case 60 by screwing a plurality of bolts 80 shown in FIG. 6 into the bolt insertion holes 61 of the first case 60.

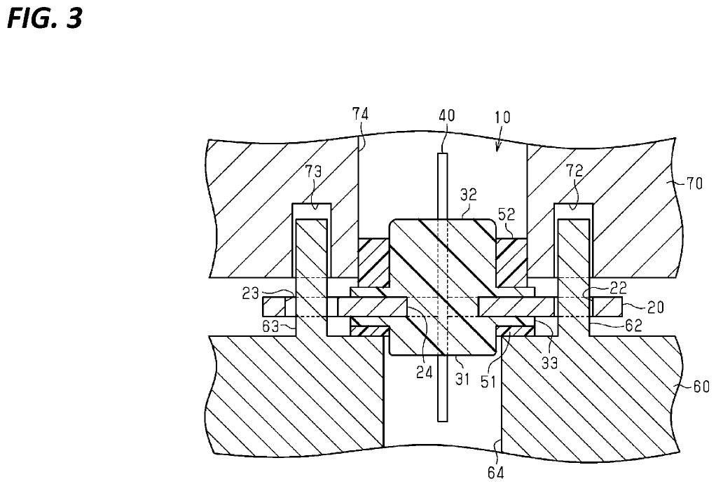

As shown in FIG. 3, the first case 60 includes a first positioning pin 62, a second positioning pin 63 and a terminal block insertion opening 64. The first and second positioning pins 62, 63 are provided to position the first case 60 and the terminal block 10. Further, the first and second positioning pins 62, 63 are provided to position the first and second cases 60, 70. The first and second positioning pins 62, 63 project from an outer surface of the first case 60.

The terminal block insertion opening 64 is provided to insert a part of the terminal block 10. The terminal block insertion opening 64 penetrates through the first case 60. The terminal block insertion opening 64 is formed to communicate an interior space of the first case 60 and an exterior space of the first case 60.

The first case 60 is made of metal. An aluminum-based or iron-based metal material can be, for example, used as a material of the first case 60. Surface processing such as tin plating or aluminum plating may be applied to the first case 60 according to the type of the constituent metal and a use environment of the first case 60.

The second case 70 includes a first pin hole 72, a second pin hole 73 and a terminal block insertion opening 74. The first positioning pin 62 is inserted into the first pin hole 72. The second positioning pin 63 is inserted into the second pin hole 73. The second case 70 is positioned with respect to the first case 60 by inserting the first and second positioning pins 62, 63 of the first case 60 into the first and second pin holes 72, 73.

The terminal block insertion opening 74 is provided to insert a part of the terminal block 10. The terminal block insertion opening 74 penetrates through the second case 70. The terminal block insertion opening 74 is formed to communicate an interior space of the second case 70 and an exterior space of the second case 70.

The first case 60 is made of metal. A material of the first case 60 is, for example, an iron-based or aluminum-based metal material. Surface processing such as tin plating or aluminum plating may be applied to the first case 60 according to the type of the constituent metal and a use environment of the first case 60.

(Configuration of Terminal Block)

As shown in FIGS. 1 to 3, the terminal block 10 includes a plate 20, a housing 30, a plurality of terminals 40 and sealing members 51, 52.

The plate 20 of the terminal block 10 is configured to be fixed to the first case 60. The housing 30 is integrally molded to the plate 20. The plurality of terminals 40 are held in the housing 30 while penetrating through the plate 20 in a plate thickness direction of the plate 20.

As shown in FIG. 1, the plate 20 includes a plurality of fixing holes 21 through which the bolts 80 shown in FIG. 5 are inserted, a first positioning hole 22 through which the first positioning pin 62 is inserted, and a second positioning hole 23 through which the second positioning pin 63 is inserted. As shown in FIG. 3, the plate 20 includes an opening 24. The fixing holes 21, the first positioning hole 22, the second positioning hole 23 and the opening 24 penetrate through the plate 20 having a metal flat plate material as a base material in the plate thickness direction. The plate 20 is formed, for example, by stamping a metal plate into a predetermined shape by press-working. The plurality of fixing holes 21, the first positioning hole 22, the second positioning hole 23 and the opening 24 are simultaneously formed in forming the plate 20. Note that the plate 20 may have a bent part.

The housing 30 includes a first inserting portion 31 disposed below the plate 20, a second inserting portion 32 disposed above the plate 20 and a plate-like flange portion 33 protruding outward from the first and second inserting portions 31, 32 along the plate 20.

As shown in FIG. 3, the first inserting portion 31 is inserted into the terminal block insertion opening 64 of the first case 60. The sealing member 51 is fixed to the lower surface of the flange portion 33. The sealing member 51 is made of rubber. The sealing member 51 seals between the flange portion 33 and the first case 60.

The second inserting portion 32 is inserted into the terminal block insertion opening 74 of the second case 70. The sealing member 52 is externally fit to the second inserting portion 32. The sealing member 52 is, for example, made of rubber. The sealing member 52 seals between the second inserting portion 32 and the second case 70.

The housing 30 of this embodiment includes a connector portion 35. The connector portion 35 may be a signal connector configured to send and receive electrical signals between the motor serving as the electrical device including the first case 60 and the inverter serving as the electrical device including the second case 70. Note the connector portion 35 may be omitted.

The plurality of terminals 40 are, for example, in the form of plates. Each terminal 40 is made of electrically conductive metal. A material of each terminal 40 is, for example, a copper-based or aluminum-based metal material. Each terminal 40 is formed, for example, by stamping an electrically conductive metal plate into a predetermined shape by press-working. As shown in FIG. 1, the plurality of terminals 40 are arrayed along a dashed-dotted line A1. A direction along this dashed-dotted line A1 is a first direction. As shown in FIG. 3, each terminal 40 is arranged to vertically penetrate through the opening 24 of the plate 20. Each terminal 40 is integrated with the housing 30. For example, each terminal 40 is integrally mounted in the housing 30 by insert molding.

(Description of First Positioning Hole and Second Positioning Hole)

As shown in FIG. 1, the first and second positioning holes 22, 23 are arrayed along a dashed-dotted line A2. A direction along this dashed-dotted line A2 is a second direction. This second direction preferably intersects the first direction in which the plurality of terminals 40 are arrayed. Further, the first and second positioning holes 22, 23 are preferably arranged across the respective terminals 40 when viewed from the first direction indicated by the dashed-dotted line A1. A distance between the first and second positioning holes 22, 23 can be increased by intersecting the array direction of the first and second positioning holes 22, 23 and the array direction of the respective terminals 40.

For example, the distance between the first and second positioning holes 22, 23 in the first direction along the dashed-dotted line A2 is made constant. The distance between the first and second positioning holes 22, 23 is longer when the first and second direction intersect than when the second direction in which the first and second positioning holes 22, 23 are arrayed is parallel to the first direction. If the sizes of the first and second positioning holes 22, 23 and those of the first and second positioning pins 62, 63 are not changed, the inclination of the terminal block 10 along the surface of the plate 20 is smaller as the distance between the first and second positioning holes 22, 23 increases. That is, the positioning accuracy of the terminal block 10 is improved as the distance between the first and second positioning holes 22, 23 increases.

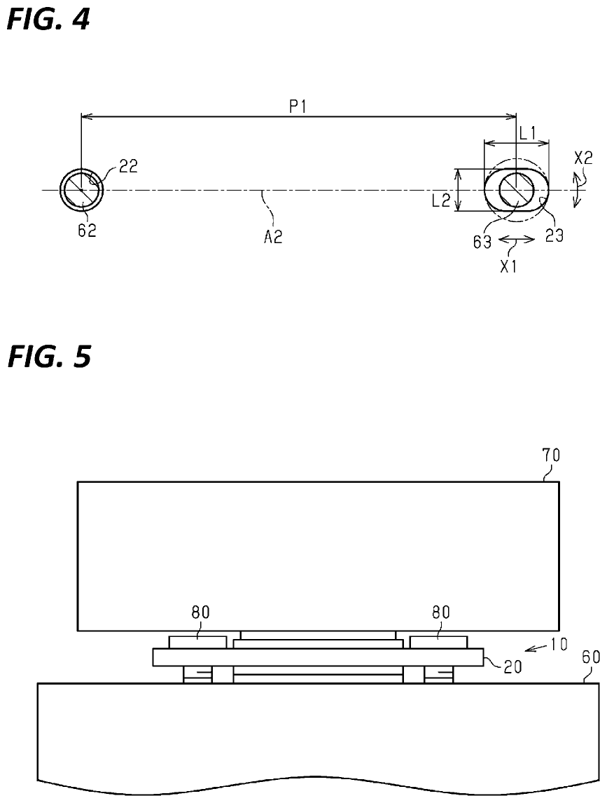

As shown in FIGS. 3 and 4, in this embodiment, the first and second positioning pins 62, 63 have a cylindrical shape and a diameter of the first positioning pin 62 is equal to that of the second positioning pin 63. The first positioning hole 22 has, for example, a circular shape when viewed from the plate thickness direction of the plate 20. The second positioning hole 23 is shaped to be long in the second direction along the dashed-dotted line A2. A length L1 of the second positioning hole 23 in the second direction is longer than a diameter of the first positioning holes 22. Further, a length L2 of the second positioning hole 23 in a third direction orthogonal to the second direction is equal to the diameter of the first positioning hole 22. In this embodiment, the second positioning hole 23 has an oval shape extending along the second direction. The oval shape is, for example, a rectangular shape with rounded corners having two parallel lines of an equal length and two semicircles respectively connecting both ends of the parallel lines. The length L1 of the second positioning hole 23 is set to absorb a distance variation between the first and second positioning pins 62, 63.

Next, functions and effects of this embodiment are described.

(1) The terminal block 10 includes the plate 20 made of metal and to be fixed to the first case 60 made of metal, the housing 30 held on the plate 20 and the plurality of terminals 40 held in the housing 30. The plate 20 includes the first positioning hole 22 through which the first positioning pin 62 is inserted.

According to this configuration, the terminal block 10 is positioned with respect to the first case 60 by the first positioning pin 62 inserted through the first positioning hole 22 of the plate 20. Since being made of metal, the plate 20 and the first case 60 have small shape errors and are formed with small tolerances as compared to the case of the positioning pins 104 made of resin as shown in FIG. 6. Thus, it is not necessary to set large tolerances between the first case 60 and the terminal block 10 and between the terminal block 10 and the second case 70. As a result, the enlargement of the terminal block 10 can be suppressed.

For example, the size of the terminal block insertion opening 74 of the second case 70 is set according to a positional deviation of the terminal block 10. By assembling the terminal block 10 with the first case 60 with high accuracy, the terminal block insertion opening 74 can also be made small. As a result, the physical size of the sealing member 52 for sealing between the terminal block insertion opening 74 of the second case 70 and the second inserting portion 32 of the housing 30 of the terminal block 10 can be reduced. Since a distance variation between the terminal block insertion opening 74 of the second case 70 and the second inserting portion 32 of the housing 30 is reduced, the separation of the sealing member 52 from the second case 70 or the housing 30 can be suppressed and sealability can be improved.

(2) The first case 60 includes the second positioning pin 63 projecting toward the second case 70, the second case 70 includes the second pin hole 73 into which the second positioning pin 63 is inserted, and the plate 20 includes the second positioning hole 23 through which the second positioning pin 63 is inserted.

According to this configuration, the terminal block 10 can be positioned, for example, with respect to a rotation direction about the first positioning pin 62 by the first positioning pin 62 inserted through the first positioning hole 22 and the second positioning pin 63 inserted through the second positioning hole 23.

(3) The plurality of terminals 40 are arrayed along the first direction, and the first and second positioning holes 22, 23 are arrayed along the second direction intersecting the first direction and arranged across the plurality of terminals 40 when viewed from the first direction.

According to this configuration, the distance between the first and second positioning holes 22, 23 can be increased by arranging the first and second positioning holes 22, 23 across the terminals 40. In this way, the terminal block 10 can be positioned with high accuracy in the rotation direction of the terminal block 10.

(4) The first positioning hole 22 has a circular shape, and the second positioning hole 23 has a rectangular shape with rounded corners extending along the second direction and having the length L2 in the third direction orthogonal to the second direction equal to the diameter of the first positioning hole 22 and the length L1 in the second direction longer than the diameter of the first positioning hole 22.

As shown in FIG. 4, the first positioning hole 22 is sized such that the first positioning pin 62 is insertable therethrough. A pitch P1, which is an array interval between the first and second positioning pins 62, 63, has a reduced error since the first case 60 including the first and second positioning pins 62, 63 is made of metal. However, the pitch P1 may vary in manufacturing. The second positioning hole 23 long in the second direction absorbs variations of the pitch P1 between the first and second positioning pins 62, 63 in directions of arrows X1 and facilitates the assembling of the terminal block 10 with the first case 60.

The variation of the pitch P1 between the first and second positioning pins 62, 63 can be absorbed even if the second positioning hole 23 has a circular shape as shown by a two-dot chain line in FIG. 4. However, with the circular second positioning hole 23, a gap between the second positioning hole 23 and the second positioning pin 63 becomes larger in the third direction orthogonal to the second direction indicated by the dashed-dotted line A2. That is, tolerances for the inclination of the terminal block 10 shown in FIG. 1 are larger than the second positioning hole 23 having a rectangular shape with rounded corners. In this case, the terminal block 10 is inclined in directions of arrows X2 shown in FIG. 4. Accordingly, by forming the second positioning hole 23 into a rectangular shape with rounded corners as in this embodiment, the positioning accuracy of the terminal block 10 can be improved. Therefore, the suppression of the inclination of the terminal block 10 and workability in assembling the terminal block 10 with the first case 60 can be combined.

(Modifications)

This embodiment can be modified and carried out as follows. This embodiment and the following modifications can be carried out in combination without technically contradicting each other.

The shape of the second positioning hole 23 may be changed as appropriate. For example, the second positioning hole 23 can have a circular shape as shown by the two-dot chain line of FIG. 4. Also in this modification, the inclination of the terminal block 10 in the directions of the arrows X2 can be made smaller than in the case of using positioning pins made of resin. Therefore, mounting position accuracy can be improved also by this modification as compared to the terminal block 100 as a reference example shown in FIG. 6.

The second positioning pin 63 may be provided outside the plate 20. In this case, the terminal block 10 is positioned by the first positioning pin 62. Positioning accuracy by the first positioning pin 62 can be improved as compared to the case where a positioning pin made of resin is used.

The first positioning hole 22 may have a polygonal shape. For example, the first positioning hole 22 may have a polygonal shape having three or more angles and circumscribing the circular first positioning hole 22 shown in FIG. 4.

The second positioning hole 23 may have a polygonal shape. For example, the second positioning hole 23 may have a rectangular shape having long sides along the dashed-dotted line A2 shown in FIG. 4.

The number of the terminals 40 of the terminal block 10 may be two, four or more.

As shown in FIG. 3, the terminal block 10 may be configured to be directly connected to both the first case 60 and the second case 70 without via a wiring harness for electrically connecting an output terminal of the inverter and an input terminal of the motor by contacting those terminals.

An assembly including the terminal block 10, the first case 60 and the second case 70 may be called a connection structure of the plurality of cases 60, 70 and the terminal block 10.

The first pin hole 72, the second pin hole 73 and the first positioning hole 22 of the shown embodiment each having a circular shape are an example of holes having an isotropic shape in a plan view of the plate 20. The second positioning hole 23 of the shown embodiment having a rectangular shape with rounded corners is an example of a hole having an anisotropic shape in the plan view of the plate 20.

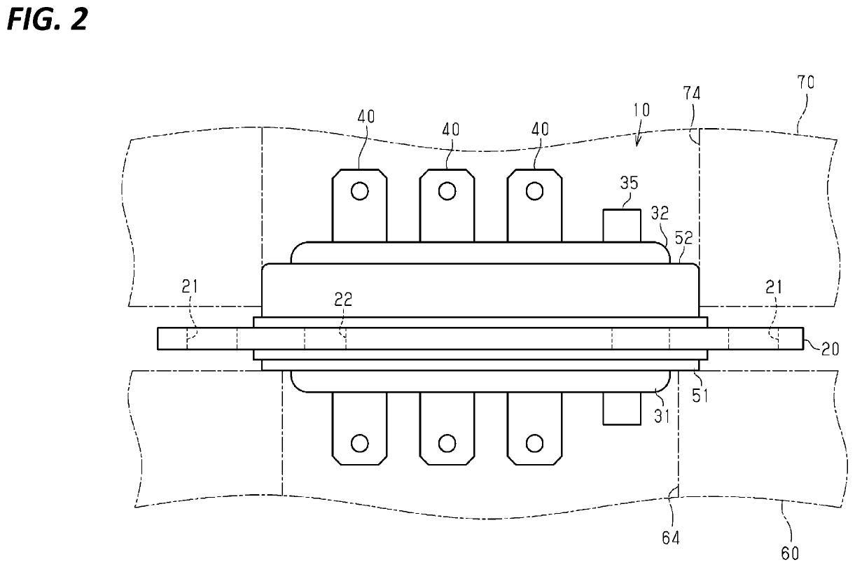

As in an example shown in FIG. 2, each terminal 40 may be a metal one-piece product having an inverter-side connection end or first end to be connected to the output terminal of the inverter, for example, by fastening and a motor-side connection end or second end to be connected to the input terminal of the motor, for example, by fastening. Each terminal 40 may extend, for example, straight from the first end to the second end.

In an example shown in FIG. 3, an outer surface (upper surface in FIG. 3) of the first case 60 from which the first positioning pin 62 projects may be called a first mount surface. An outer surface (lower surface in FIG. 3) of the second case 70 formed with the first pin hole 72 may be called a second mount surface. As shown in FIG. 3, the first and second mount surfaces may face each other across a predetermined space with the terminal 10, the first case 60 and the second case 70 assembled. This predetermined space may be smaller than a height of the terminal block 10, which can be a distance between the upper end of the terminal block 10 possibly serving as the first end of the terminal 40 and the lower end of the terminal block 10 possibly serving as the second end of the terminal 40. The terminal block 10 shown in FIG. 3 is advantageous in proximately connecting the first case 60 and the second case 70. In the example of FIG. 3, the terminal block 10 is arranged between the first mount surface of the first case 60 and the second mount surface of the second case 70 and configured to limit relative movement amounts of the first case 60 and the second case 70 at least in an in-plane direction parallel to the first mount surface or prevent relative movements in the in-plane direction.

As in the example shown in FIG. 3, the plate 20 may be a metal one-piece product having a first plate surface and a second plate surface opposite to the first plate surface, and the plate 20 may have a constant thickness. The first and second plate surfaces of the plate 20 may respectively face the first mount surface of the first case 60 and the second mount surface of the second case 70. The first, second and third directions described in this embodiment may be three linear directions orthogonal to each other and may be indicated by three straight lines intersecting each other on a plane parallel to the first or second plate surface of the plate 20. A direction parallel to the first and second plate surfaces of the plate 20 may be called an in-plane direction of the plate 20.

The present disclosure includes the following aspects. Reference signs of several constituent elements of the illustrative embodiment are given not for limitation, but for understanding assistance. Matters described in the following aspects may be partly omitted or several of the matters described in the following aspects may be selected or extracted and combined.

[Addendum 1] Several aspects of the present disclosure are directed to an assembly including a first case (60) made of metal, a second case (70) made of metal and a terminal block (10), wherein:

the first case (60) may have a first mount surface and a first positioning pin (62) projecting from the first mount surface,

the first positioning pin (62) may include a base end part to be seamlessly connected to the first mount surface, a tip part opposite to the base end part and an intermediate part between the base end part and the tip part,

the second case (70) may have a second mount surface and a first pin hole (72) formed in the second mount surface, the tip part of the first positioning pin (62) being inserted into the first pin hole (72) with a first radial space formed between the tip part and the first pin hole (72),

the terminal block (10) may include a metal plate (20) configured to be fixed to the first mount surface of the first case (60), a terminal (40) penetrating through the metal plate (20), and an insulating housing (31) for fixing the terminal (40) to the metal plate (20) while insulating the terminal (40) and the metal plate (20), and

the metal plate (20) may include a first positioning hole (22), the intermediate part of the first positioning pin (62) being inserted through the first positioning hole (22) with a second radial space smaller than the first radial space formed between the intermediate part and the first positioning hole (22).

[Addendum 2] In the assembly according to one aspect of the present disclosure,

the first case (60) may include a second positioning pin (63) projecting from the first mount surface and different from the first positioning pin (62),

the second positioning pin (63) may include a base end part to be seamlessly connected to the first mount surface, a tip part opposite to the base end part and an intermediate part between the base end part and the tip part,

the second case (70) may have a second pin hole (73) formed in the second mount surface, the tip part of the second positioning pin (63) being inserted into the second pin hole (73) with a third radial space formed between the tip part and the second pin hole (73),

the metal plate (20) may include a second positioning hole (23), the intermediate part of the second positioning pin (63) being inserted through the second positioning hole (23) with a fourth radial space formed between the intermediate part and the second positioning hole (23),

each of the first radial space, the second radial space and the third radial space may be isotropic in an in-plane direction of the metal plate (20), and

the fourth radial space may be anisotropic in the in-plane direction of the metal plate (20).

[Addendum 3] In the assembly according to one aspect of the present disclosure,

each of the first pin hole (72), the second pin hole (73) and the first positioning hole (22) may have an isotropic shape in a plan view of the metal plate (20) and the second positioning hole (23) may have an anisotropic shape in the plan view of the metal plate (20).

[Addendum 4] In the assembly according to one aspect of the present disclosure,

the first positioning hole (22) and the second positioning hole (23) may be aligned on a predetermined straight line (A2) in a plan view of the metal plate (20),

a hole diameter (L1) of the second positioning hole (23) may be larger than a hole diameter of the first positioning hole (22) when being measured along the predetermined straight line (A2), and

the hole diameter (L1) of the second positioning hole (23) may be equal or substantially equal to the hole diameter of the first positioning hole (22) when being measured along another straight line orthogonal to the predetermined straight line (A2) in the plan view of the metal plate (20).

[Addendum 5] In the assembly according to one aspect of the present disclosure,

the first positioning hole (22) and the second positioning hole (23) may be aligned on a predetermined straight line (A2) in a plan view of the metal plate (20),

the fourth radial space is larger than the third radial space when being measured along the predetermined straight line (A2), and

the fourth radial space may be equal or substantially equal to the third radial space when being measured along another straight line orthogonal to the predetermined straight line (A2) in the plan view of the metal plate (20).

[Addendum 6] In the assembly according to one aspect of the present disclosure,

the first positioning hole (22) may be a single first positioning hole (22), and the second positioning hole (23) may be a single second positioning hole (23).

[Addendum 7] In the assembly according to one aspect of the present disclosure,

the first mount surface may include one or more bolt insertion holes (61), and

the metal plate (20) may include one or more fixing holes (21) corresponding to the one or more bolt insertion holes (61) and a hole diameter of the one or more fixing holes (21) may be larger than a hole diameter of the one or more bolt insertion holes (61).

[Addendum 8] In the assembly according to one aspect of the present disclosure,

the metal plate (20) may have a first plate surface facing the first mount surface and a second plate surface opposite to the first plate surface and facing the second mount surface.

[Addendum 9] A terminal block (10) according to several aspects of the present disclosure may include:

a metal plate (20);

a terminal (40) penetrating through the metal plate (20); and

an insulating housing (31) for fixing the terminal (40) to the metal plate (20) while insulating the terminal (40) and the metal plate (20),

wherein:

the metal plate (20) may include a first positioning hole (22) and a second positioning hole (23) aligned on a predetermined straight line (A2) in a plan view of the metal plate (20),

an inner diameter of the second positioning hole (23) may be larger than an inner diameter of the first positioning hole (22) when being measured along the predetermined straight line (A2), and

the inner diameter of the second positioning hole (23) may be equal or substantially equal to the inner diameter of the first positioning hole (22) when being measured along another straight line orthogonal to the predetermined straight line (A2) in the plan view of the metal plate (20).

[Addendum 10] In several aspects of the present disclosure,

the terminal block (10) is used together with a first case (60) and a second case (70),

the first case (60) may have a first mount surface including a first positioning pin (62) and a second positioning pin (63),

the first positioning pin (62) and the second positioning pin (63) may have the same diameter,

the second case (70) may have a second mount surface including a first pin hole (72) and a second pin hole (73) into which the first positioning pin (62) and the second positioning pin (63) are respectively inserted,

the metal plate (20) of the terminal block (10) may be configured to be arranged between the first mount surface and the second mount surface and fixed to the first mount surface, and

the first positioning hole (22) and the second positioning hole (23) of the metal plate (20) may be configured such that the first positioning pin (62) and the second positioning pin (63) are respectively inserted therethrough.

The embodiment disclosed this time should be considered illustrative in all aspects, rather than restrictive. The scope of the present invention is represented not by the above meaning, but by claims and is intended to include all changes in the scope of claims and in the meaning and scope of equivalents.

### LIST OF REFERENCE NUMERALS

10 terminal block

20 plate

21 fixing hole

22 first positioning hole

23 second positioning hole

24 opening

30 housing

31 first inserting portion

32 second inserting portion

33 flange portion

35 connector portion

40 terminal

51 sealing member

52 sealing member

60 first case

61 bolt insertion hole

62 first positioning pin

63 second positioning pin

64 terminal block insertion opening

70 second case

72 first pin hole

73 second pin hole

74 terminal block insertion opening

80 bolt

L1, L2 length of second positioning hole

What is claimed is:

1. A terminal block to be interposed between a first case and a second case, wherein:
the first case is made of metal and includes a first positioning pin projecting toward the second case,
the second case is made of metal and includes a first pin hole, the first positioning pin being inserted into the first pin hole,
the terminal block includes:
a plate made of metal and to be fixed to the first case;
a housing held on the plate; and
a plurality of terminals held in the housing, and
the plate includes a first positioning hole, the first positioning pin being inserted through the first positioning hole.

2. The terminal block of claim 1, wherein;
the first case includes a second positioning pin projecting toward the second case,
the second case includes a second pin hole, the second positioning pin being inserted into the second pin hole, and
the plate includes a second positioning hole, the second positioning pin being inserted through the second positioning hole.

3. The terminal block of claim 2, wherein:
the plurality of terminals are arrayed along a first direction, and
the first positioning hole and the second positioning hole are arrayed along a second direction intersecting the first direction and arranged across the plurality of terminals when viewed from the first direction.

4. The terminal block of claim 3, wherein:
the first positioning hole has a circular shape,
the second positioning hole extends along the second direction,
a length of the second positioning hole in a third direction orthogonal to the second direction is equal to a diameter of the first positioning hole, and
a length of the second positioning hole in the second direction is longer than the diameter of the first positioning hole.
